(19) United States
(12) Patent Application Publication
(10) Pub. No.: US 2016/0378767 A1
(43) Pub. Date: Dec. 29, 2016

(54) INFORMATION EXTRACTION METHOD, INFORMATION PROCESSING DEVICE, AND COMPUTER-READABLE STORAGE MEDIUM STORING INFORMATION EXTRACTION PROGRAM

(71) Applicant: FUJITSU LIMITED, Kawasaki-shi (JP)

(72) Inventors: Tatsuya Yamamoto, Kawasaki (JP); Hidetoshi MATSUOKA, Yokohama (JP)

(73) Assignee: FUJITSU LIMITED, Kawasaki-shi (JP)

(21) Appl. No.: 15/097,617

(22) Filed: Apr. 13, 2016

(30) Foreign Application Priority Data
Jun. 24, 2015 (JP) 2015-126705

(51) Int. Cl. G06F 17/30

(52) U.S. Cl. CPC G06F 17/3053; G06F 17/30554; G06F 17/30345

(57) ABSTRACT

An information extraction method, includes: extracting, by a computer, a plurality of item candidates that are candidates of Pareto-optimal items from among items included in item information, based on a search condition; obtaining an order of the plurality of candidates based on history information indicating previously-selected items; calculating a score for each of one or more first items that do not satisfy the search condition and is included in the item information based on the order; and outputting one or more second items having a score which satisfies a specific condition from among the one or more first items based on the score.

### CROSS-REFERENCE TO RELATED APPLICATION

This application is based upon and claims the benefit of priority of the prior Japanese Patent Application No. 2015-126705, filed on Jun. 24, 2015, the entire contents of which are incorporated herein by reference.

### FIELD

The embodiments discussed herein are related to an information extraction method, an information processing device, and a computer-readable storage medium storing an information extraction program.

### BACKGROUND

In a system (information recommendation system), an item that matches a user's taste is extracted from items corresponding to a search condition, from among a large amount of items (information) accumulated in a database (DB) or the like, and the extracted item is recommended to the user when the search condition has been accepted from the user.

A technique in a related art is discussed in Japanese Laid-open Patent Publication No. 2014-203442.

### SUMMARY

According to an aspect of the embodiments, an information extraction method, includes: extracting, by a computer, a plurality of item candidates that are candidates of Pareto-optimal items from among items included in item information, based on a search condition; obtaining an order of the plurality of candidates based on history information indicating previously-selected items; calculating a score for each of one or more first items that do not satisfy the search condition and is included in the item information based on the order; and outputting one or more second items having a score which satisfies a specific condition from among the one or more first items based on the score.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary function configuration of an information extraction device;

FIG. 2 is a diagram illustrating an exemplary flag assignment processing;

FIG. 3 is a diagram illustrating an exemplary user previous item selection history table;

FIG. 4 is a diagram illustrating an exemplary Pareto generation;

FIG. 5 is a diagram illustrating an exemplary substitution with components on a Pareto curve;

FIG. 6 is a diagram illustrating an exemplary history adjustment;

FIG. 7 is a diagram illustrating an exemplary score calculation processing;

FIG. 8 is a diagram illustrating exemplary scores of items on planes;

FIG. 9 is a diagram illustrating an exemplary projection of the planes in two dimensions;

FIG. 10 is a diagram illustrating an exemplary item-score table;

FIG. 11 is a diagram illustrating an exemplary generation of a recommendation item candidate table;

FIG. 12 is a diagram illustrating an exemplary display screen;

FIG. 13 is a diagram illustrating an exemplary Pareto generation;

FIG. 14 is a diagram illustrating an exemplary history adjustment;

FIG. 15 is a diagram illustrating an exemplary item candidate;

FIG. 16 is a diagram illustrating an exemplary score of item candidates;

FIG. 17 is a diagram illustrating an exemplary generation of a recommendation item candidate table; and

FIG. 18 is a diagram illustrating an exemplary computer.

### DESCRIPTION OF EMBODIMENTS

For example, the method in which an item that matches the user's taste is extracted includes a user-based recommendation method, an item-based recommendation method, and a method in which the user-based recommendation method and the item-based recommendation method are mixed. In the user-based recommendation method, an item that the user has accessed previously is determined to correspond to “taste of the user”, and an item that a further user having a similar taste has accessed is recommended to the user. In the item-based recommendation method, an item similar to the item that the user has accessed previously is recommended to the user. In the method in which the user-based recommendation method and the item-based recommendation method are mixed, both of the user-based recommendation method and the item-based recommendation method are used.

For example, the user searches for a desirable item by inputting a search condition and checking a search result that has been extracted as an item that matches the user's taste by using the above-described recommendation method.

In the above-described recommendation methods, it may take time for the user to find the desirable item.

For example, in the above-described recommendation methods, an item that matches the user's taste is recommended from among the items corresponding to the input search condition. Therefore, a further desirable item may be recommended by changing the search condition. The user finds a desirable item by repeatedly inputting a different search condition, checking the search result, and considering an item included in the search result.

An identical symbol is assigned to configurations having the same or similar function, and the duplicated description may be omitted herein.

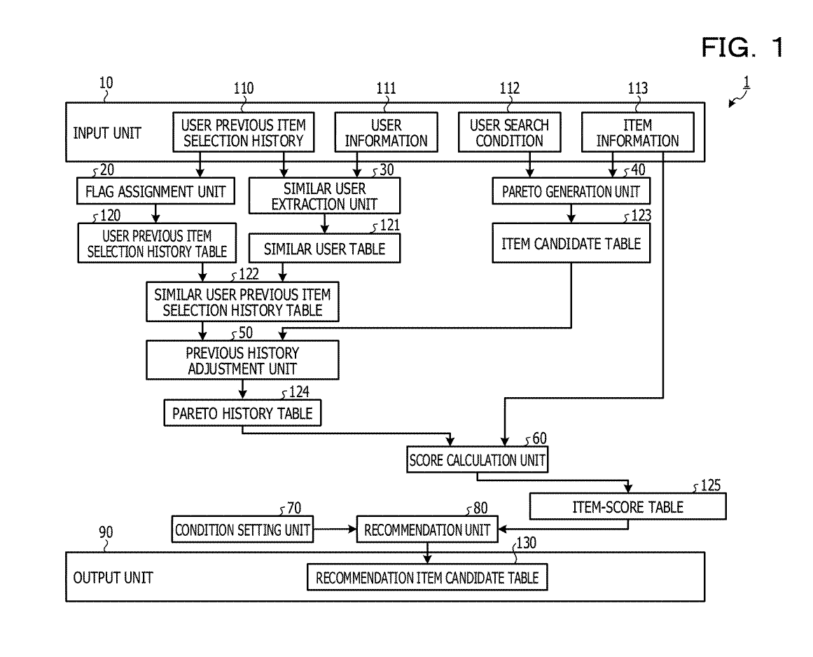

FIG. 1 is a diagram illustrating an exemplary function configuration of an information extraction device. An information extraction device 1 is, for example, a personal computer or the like, and accepts a search condition for an item (information) by an operation of the user through an input device such as a keyboard and a mouse. The information extraction device 1 extracts an item corresponding to the search condition from among a large amount of items accumulated in the item information 113 and recommends the extracted item to the user through output of the item to an output device such as a display.

A single device such as a personal computer may recommend an item, and a system including a terminal device and a server device may recommend an item. For example, the system may include a terminal device operated by the user and a server device that searches for an item in response to a search request from the terminal device and outputs a search result to the terminal device.

An item as a search target may be an electronic component (hereinafter may be referred to as a component). An item as a search target may be other than an electronic component, and may be, for example, a product, a property, or the like.

The item as the search target includes a plurality of elements and each of the elements has a value that characterizes the item. For example, the component may include elements such as life, cost, temperature resistance, and an error in addition to elements indicating electrical characteristics such as a resistance value and rated power. A certain element has the range of a value, and the direction (desirability) such as “good” or “bad” may be determined depending on the value. For example, it may be determined that it is bad (less profitable) when the cost is high, and may be determined that it is good (more profitable) when the cost is low. It may be determined that it is bad (less profitable) when the life is long, and may be determined that it is good (more profitable) when the life is short.

As illustrated in FIG. 1, the information extraction device 1 includes an input unit 10, a flag assignment unit 20, a similar user extraction unit 30, a Pareto generation unit 40, a previous history adjustment unit 50, a score calculation unit 60, a condition setting unit 70, a recommendation unit 80, and an output unit 90. Each of the above-described function units is achieved when a central processing unit (CPU) of the information extraction device 1 executes a program.

The input unit 10 accepts inputs of information such as a user previous item selection history 110, user information 111, a user search condition 112, and item information 113, from a storage device that stores data in advance and the input device such as the keyboard and the mouse.

The user previous item selection history 110 is information in which a history of items that have been previously selected by the user is described. The user previous item selection history 110 is managed in the storage device or the like, and information indicating a selected item is added to the user previous item selection history 110 as a history when a selection instruction of the item is accepted from the user. For example, the information indicating the selected item (item name or the like), identification information indicating the user who has selected the item (user ID or the like), and information such as the selected date and time are described in the user previous item selection history 110.

The user information 111 is information indicating the user who has input the user search condition 112. For example, the user ID of the user who has been authenticated through login authentication or the like at the time of item search is input as the user information 111.

The user search condition 112 is a condition used to search for the item, which has been received from the user through the input device such as the keyboard or the mouse, and is a condition of a value in each of the elements of the item. For example, the user search condition 112 may include electrical characteristic values (resistance value and the like) and condition values of temperature resistance, a cost, and an error of the component that is the search target.

The item information 113 is information on various items that are search targets, and is managed in the storage device or the like. For example, the item information 113 may correspond to a DB in which information of a single item is described for each record, and values in elements are described for each of the items in the item information 113. For example, in the item information 113, the values of the elements such as the resistance value, the temperature resistance, the cost, and the error are described for each of the components.

The flag assignment unit 20 generates a user previous item selection history table 120 to which a flag indicating selection order of the items that have been previously selected (hereinafter may be referred to as a selection flag) has been assigned for each of the users based on the user previous item selection history 110 that has been input through the input unit 10. For example, the flag assignment unit 20 sections a certain interval for a history of the items that have been previously selected for each of the users, assigns a selection flag of “Refer” to an item that has been selected within the interval, and assigns a selection flag of “Select” to an item that has been finally selected.

For example, when the user repeatedly searches for a desirable item, an item that has been selected later may be the desirable item for the user as compared with an item that has been selected previously. An item that has been finally selected within a certain time period may be the most desirable item for the user. Thus, in the flag assignment unit 20, when the selection flag of “Refer” or “Select” is assigned to the item that the user has selected previously, creation of meaning of the items corresponding to the selection order is performed.

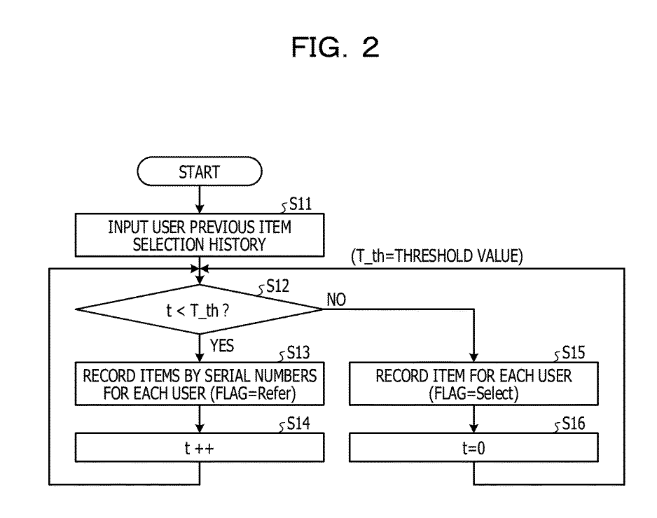

FIG. 2 is a diagram illustrating an exemplary flag assignment processing. As illustrated in FIG. 2, the flag assignment unit 20 accepts an input of the user previous item selection history 110 (S1), and assigns a selection flag to an item using an interval corresponding to a threshold value (T_th) that has been set in advance, based on information on the date and time in which the item has been selected.

For example, the flag assignment unit 20 determines whether an item has been selected in a time that is less than the threshold value (T_th) (t<T_th), based on the information on the data and time in which the item has been selected (S12). When the time is less than the threshold value (T_th) (S12: YES), the flag assignment unit 20 records the items to the user previous item selection history table 120 by using serial numbers for each of the users (S13). At that time, the flag assignment unit 20 assigns the selection flag of “Refer” to the item. The flag assignment unit 20 increments by “t” (S14), and the processing returns to S12.

When the time is equal to or more than the threshold value (T_th) (S12: NO), the flag assignment unit 20 assigns the selection flag of “Select” to the item for each of the users, and records the item and the flag to the user previous item selection history table 120 (S15). After that, the flag assignment unit 20 initializes “t” (t=0) (S16), and the processing returns to S12.

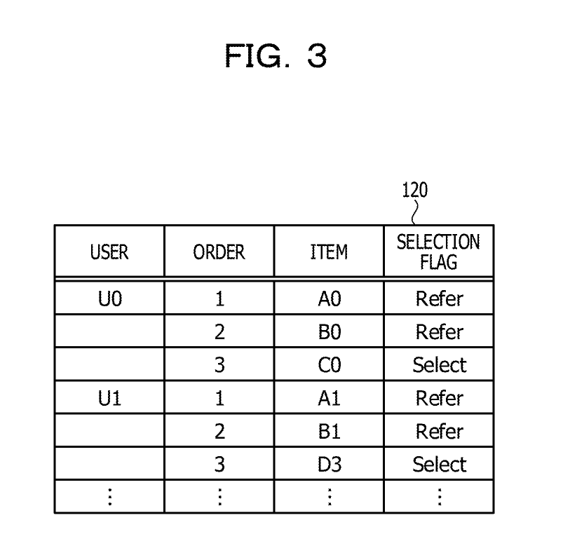

FIG. 3 is a diagram illustrating an exemplary user previous item selection history table 120. As illustrated in FIG. 3, the selection flag of “Refer” or “Select” indicating the selection order of the items is recorded to the user previous item selection history table 120 for each of the items that have been selected by each of the users. For example, for a user of “U0”, items are selected in order from “A0”, “B0”, and “C0”, and the selection flag of “Select” is recorded to the item “C0” that has been finally selected. The selection flag of “Refer” is recorded to the items “A0” and “B0” that has been selected sequentially before the item “C0”.

In FIG. 1, the similar user extraction unit 30 extracts a user who has input the user search condition 112 and a user who has previously selected an item similar to an item of the user who has input the user search condition 112, based on the user information 111 and the user previous item selection history 110. The similar user extraction unit 30 outputs information on the extracted users as a similar user table 121.

For example, the similar user extraction unit 30 identifies the user who has input the user search condition 112, based on the user information 111. The similar user extraction unit 30 obtains items that the identified user has selected previously and items that a further user have selected previously, with reference to the user previous item selection history 110. The similar user extraction unit 30 obtains the similarity between the items of the users, identifies the further user who has selected the items having the similarity of a certain value or more, as a similar user. The similar user extraction unit 30 outputs the similar user table 121 in which identification information indicating the identified user (user ID or the like) is described.

The Pareto generation unit 40 generates a Pareto solution that is Pareto-optimal under a constraint in which the user search condition 112 is satisfied (referred to as “Pareto generation”), with reference to the user search condition 112 and the item information 113. The Pareto solution is, for example, a solution in which the merit or demerit for the desirability of the life and the cost is not determined under the constraint in which the user search condition 112 is satisfied. In the Pareto generation, a method by which the value of an optimization objective function is minimized may be used. For example, a known method may be used. The Pareto generation unit 40 extracts an item corresponding to the Pareto solution from among a large amount of items described in the item information 113, and outputs information on the extracted item as an item candidate table 123.

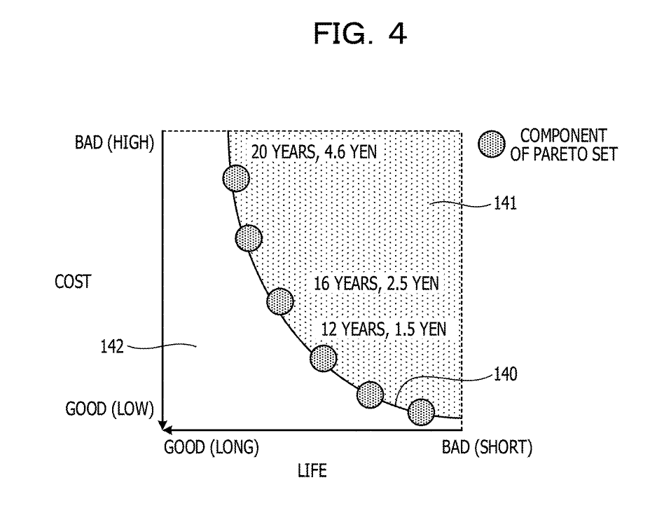

FIG. 4 is a diagram illustrating an exemplary Pareto generation. As illustrated in FIG. 4, the Pareto generation unit 40 obtains a Pareto curve 140 corresponding to the Pareto solution, by using the method by which the value of the optimization objective function is minimized. For example, the Pareto curve 140 for the life and the cost is obtained. A range 141 indicates a range corresponding to the user search condition 112. A range 142 indicates a range outside the user search condition 112. The Pareto generation unit 40 outputs information indicating items (components) of a Pareto set on the Pareto curve 140 as the item candidate table 123.

In FIG. 1, the previous history adjustment unit 50 substitutes items (components) that have been previously selected by the user described in the similar user table 121, with the components on the Pareto curve 140, and outputs a Pareto history table 124 that is information obtained after the substitution.

For example, the previous history adjustment unit 50 obtains a similar user previous item selection history table 122 that has been obtained by refining the user previous item selection history table 120 of the items (components) that the user has selected previously, by using the users described in the similar user table 121. The previous history adjustment unit 50 substitutes the components that have been selected previously with the components on the Pareto curve 140, for the users of the similar user previous item selection history table 122, with reference to the item candidate table 123 indicating the components on the Pareto curve 140. The score calculation unit 60 performs score calculation by using the components on the Pareto curve 140 as a reference, so that the previous history adjustment unit 50 associates all of the components that have been previously selected by the user with the components on the Pareto curve 140 respectively.

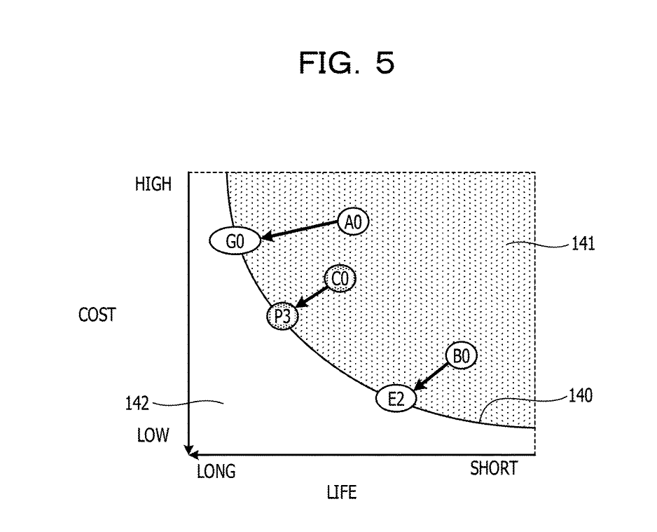

FIG. 5 is a diagram illustrating an exemplary substitution with components on a Pareto curve. As illustrated in FIG. 5, the previous history adjustment unit 50 respectively substitutes components that have been selected previously (A0, C0, and B0) with dominant components on the Pareto curve 140 (G0, P3, and E2) so that the value of the optimization objective function is minimized. From among the components that have been selected previously (A0, C0, and B0), the shaded component (C0) has the selection flag of “Select”. The non-shaded components (A0 and B0) have the selection flag of “Refer”. The corresponding selection flags are also assigned to the substituted components on the Pareto curve 140 (G0, P3, and E2).

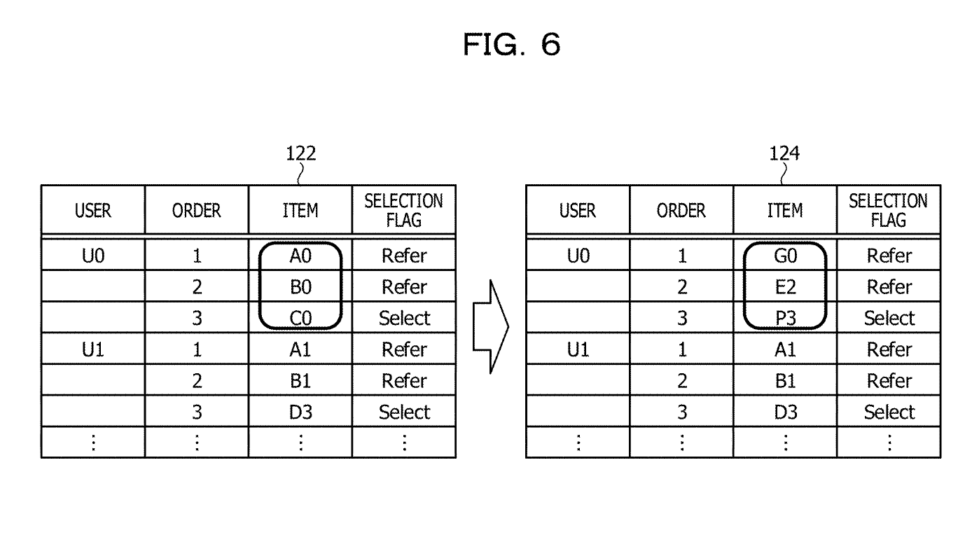

FIG. 6 is a diagram illustrating an exemplary history adjustment. As illustrated in FIG. 6, the previous history adjustment unit 50 substitutes the components that have been selected previously (A0, B0, and C0) with the components on the Pareto curve 140 (G0, E2, and P3), for the user (U0) of the similar user previous item selection history table 122. The previous history adjustment unit 50 remains the selection flags for the similar user previous item selection history table 122 and outputs the Pareto history table 124 that has been obtained by performing substitution with the components on the Pareto curve 140 (G0, E2, and P3). Thus, the Pareto history table 124 includes information that has been obtained by reflecting the selection order of the components that have been previously selected by the user on the Pareto curve 140.

In FIG. 1, the score calculation unit 60 calculates a score that corresponds to the previous selection order of the user, for each of the components that do not satisfy the user search condition 112, in the items (components) included in the item information 113, based on the Pareto history table 124 that has been obtained by reflecting the previous selection order of the user. For example, the components on the Pareto curve 140 in the Pareto history table 124 include the information that has been obtained by reflecting the previous selection order of the user, so that the score calculation unit 60 calculates a score that corresponds to the previous selection order of the user based on the Pareto history table 124, for each of the components of the item information 113. The score calculation unit 60 outputs the score that has been calculated for each of the components as an item-score table 125.

For example, the score calculation unit 60 obtains a score of each of the components of the item information 113 (height for the hyperplane), for a hyperplane that passes through the components on the Pareto curve 140 that has been obtained by reflecting the previous selection order of the user, in a multidimensional space including the elements of the components of the item information 113. The score corresponds to the score that corresponds to the previous selection order of the user.

For example, the score calculation unit 60 obtains a hyperplane that passes through a component in which the selection flag is “Select” and the selection order is last (component that has been selected as the most desirable item) and a component in which the selection flag is “Refer”, with reference to the Pareto history table 124. A plurality of hyperplanes is obtained by changing a combination with a component in which the selection flag is “Refer”. For example, the component in which the selection flag is “Select” may be included in all of the hyperplanes, and there may exist a sufficient number of other components to constitute the hyperplanes (components in each of which the selection flag is “Refer”).

The score calculation unit 60 calculates a score by obtaining a distance to each of the plurality of hyperplanes based on the following formula (1), for each of the components each of which does not satisfy the user search condition 112 in the items (components) included in the item information 113.

Score=sgΣⱼWⱼΣᵢaⱼⱼxᵢ+dⱼ/{square root over ((Σᵢ(aᵢⱼ)²))} (1)

In the formula (1), “i” is a subscript indicating a dimension, and “j” is a subscript indicating a hyperplane. Here, “a” is a coefficient, and “x” is an item, and “d” is a constant. Here, “sg” is the value of 1 or −1, and the symbol by which the score on “good” side of the hyperplane is caused to be positive is selected. Here, “Wⱼ” is a value indicating the weight of “0≦Wⱼ≦1”. It is assumed that “1” is obtained by performing addition of “Wⱼ” for all of the hyperplanes.

In the formula (1), “Σⱼαᵢⱼxᵢ+dⱼ” indicates a hyperplane. A formula obtained by dividing the formula of the hyperplane by a square root of “Σᵢ(αᵢⱼ)²” indicates the height to the hyperplane (general formula of a distance between a point and a plane). In the formula (1), the score is obtained by the weighted linear sum for the height of each of the hyperplanes.

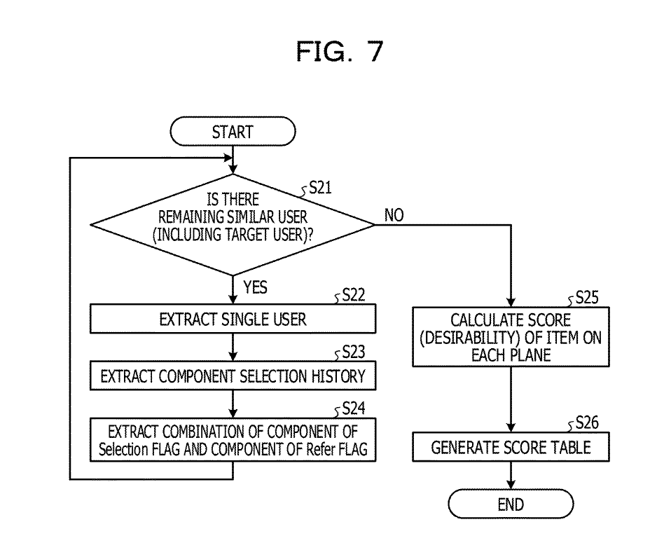

FIG. 7 is a diagram illustrating an exemplary score calculation processing. As illustrated in FIG. 7, when the processing starts, the score calculation unit 60 determines whether there is a remaining similar user for who a combination of components used to obtain a plurality of hyperplanes is not extracted, with reference to the Pareto curve 140 (S21). The similar user may include a target user who has input the user search condition 112.

When there are remaining similar users (S21: YES), the score calculation unit 60 extracts a user from the remaining similar users (S22), and extracts a component selection history that is a list of components that have been previously selected by the extracted user (S23). The score calculation unit 60 extracts a combination of a component in which the selection flag is “Select” and a component in which the selection flag is “Refer”, from the component selection history (S24), and the processing returns to S21. When there are components in each of which the selection flag is “Refer”, a plurality of combinations is obtained by changing a combination with a component in which the selection flag is “Select”.

When there is no remaining similar user (S21: NO), combinations of components used to obtain a plurality of hyperplanes have been extracted for the similar user, so that the processing proceeds to S25.

In S25, the score calculation unit 60 calculates the score (desirability) of an item (component) on each of the planes (hyperplanes) by the combinations that have been obtained in S24, based on the formula (1) (S25). The score calculation unit 60 generates an item-score table 125 that stores the score that has been obtained in S25, for each of the items (S26), and the processing ends.

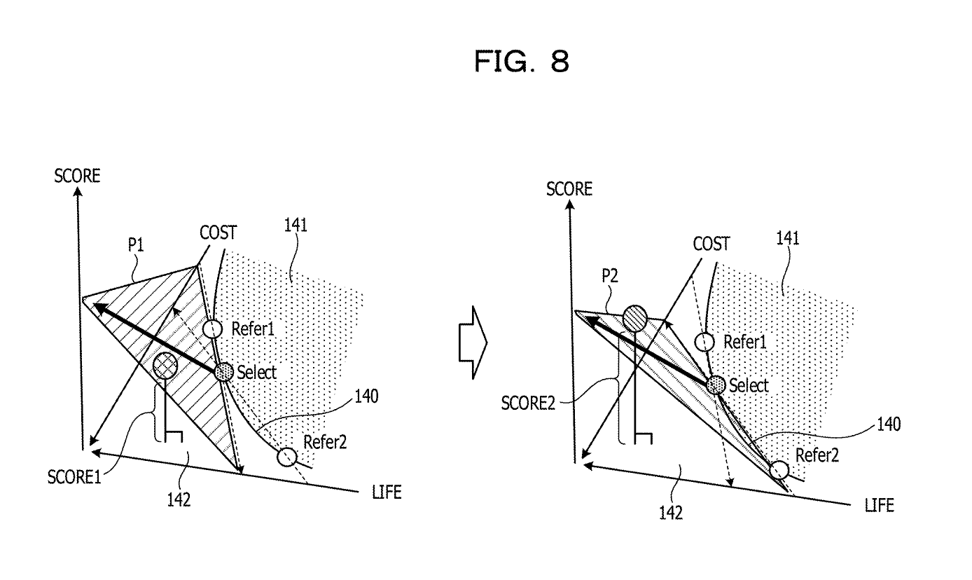

FIG. 8 is a diagram illustrating exemplary scores of items on planes. In FIG. 8, planes P1 and P2 created for two elements (cost and life) in the items are illustrated.

As illustrated in FIG. 8, the planes P1 and P2 are obtained based on combinations of items on the Pareto curve 140, to which the selection flags have been respectively assigned. The plane P1 is a plane that passes though the item of “Select” and the item of “Refer 1”. The plane P2 is a plane that passes though the item of “Select” and the item of “Refer 2”. This reflects selection tendency of the user, which indicates that the item of “Select” is more desirable than the items of “Refer 1” and “Refer 2” in both of the planes P1 and P2. A Score 2 in the plane P2 has a greater desirability (Score) on which the selection tendency of the user has been reflected, than a Score 1 in the plane P1.

Formulas of the planes P1 and P2 are respectively obtained as “α₀×Life+β₀×Cost+y₀” and “α₁×Life+β₁×Cost+y₁”. The scores of the planes P1 and P2 are obtained as “W₀×(α₀×Life+β₀×Cost+y₀)+(1−W₀) (α₁×Life+β₁×Cost+y₁)”(0≦W₀≦1) in accordance with the formula (1).

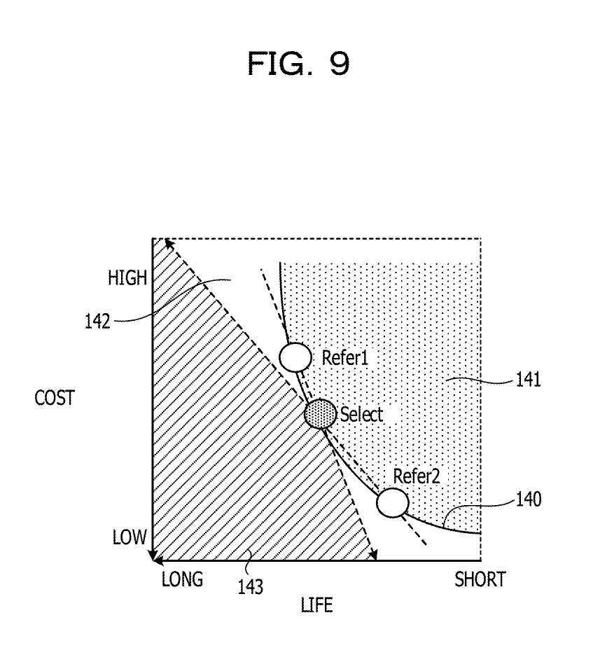

A target item on which the selection tendency of the user has been reflected exists between the above-described planes P1 and P2. FIG. 9 is a diagram illustrating an exemplary projection of the planes into two dimensions. In FIG. 9, the calculated planes (P1 and P2) are projected two-dimensionally. As illustrated in FIG. 9, the target item on which the selection tendency of the user has been reflected is included in a range 143 in which the area between the planes P1 and P2 are projected on the plane for the cost and the life.

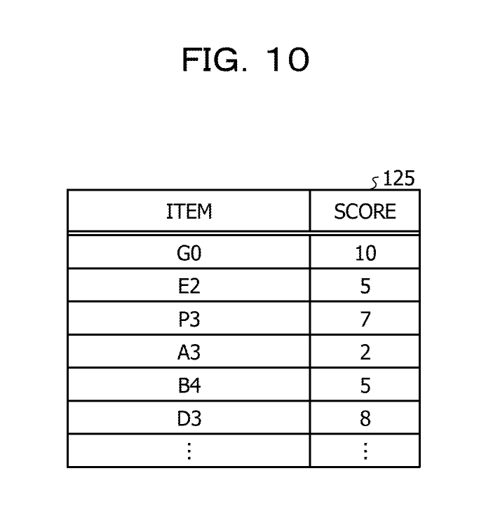

FIG. 10 is a diagram illustrating an exemplary item-score table. As illustrated in FIG. 10, the item-score table 125 stores the scores that have been obtained in S25 in addition to information used to identify each of the items (for example, item names such as G0 and E2).

In FIG. 1, the condition setting unit 70 accepts setting of a condition obtained by mitigating the user search condition 112 (mitigation condition), from the user through the input device. The condition setting unit 70 outputs the set mitigation condition to the recommendation unit 80.

For example, the condition setting unit 70 accepts setting of an allowable range outside the range of the user search condition 112, from the user as the mitigation condition. For example, the condition setting unit 70 accepts setting of an allowable range (%) by an increase (+) or decrease (−) for an initial condition (default) of the user search condition 112. The content of the mitigation condition may be a specific numeric value in addition to a proportion for the initial condition, and the content is not particularly limited.

The recommendation unit 80 describes an item corresponding to the user search condition 112 from among the item information 113 in a recommendation item candidate table 130, and outputs the data. For example, the recommendation unit 80 describes an item described in the item candidate table 123, in the recommendation item candidate table 130 as the item corresponding to the user search condition 112. The recommendation unit 80 describes an item in which the score that has been calculated by the score calculation unit 60 satisfies a certain condition, from among the items each of which does not satisfies the user search condition 112, in the recommendation item candidate table 130, with reference to the item-score table 125 and the mitigation condition from the condition setting unit 70. The recommendation unit 80 stores the item corresponding to the user search condition 112 and the item in which the score satisfies the certain condition from among the items each of which does not satisfies the user search condition 112 so that the items to which flags or the like have been assigned are allowed to be identified.

The output unit 90 generates display data used to display the item described in the recommendation item candidate table 130 as an item recommended to the user, and outputs the display data to an output device such as a display. The item recommended to the user is displayed on a display screen of the output device based on the display data.

The output unit 90 generates, for the items that have been ordered in the recommendation item candidate table 130, display data used to perform display such as display corresponding to the order, for example, display for listing the items in the order. Therefore, the user may easily recognize, for example, the recommendation order or the like of the items.

The output unit 90 generates display data used to display the item corresponding to the user search condition 112 and the item in which the score satisfies the certain condition from among the items each of which does not satisfy the user search condition 112 so as to section the items into different display modes, for example, to divide the items into different display areas. For example, the user may easily recognize the divisions between the item corresponding to the user search condition 112 and the item in which the score satisfies the certain condition from among the items each of which does not satisfy the user search condition 112.

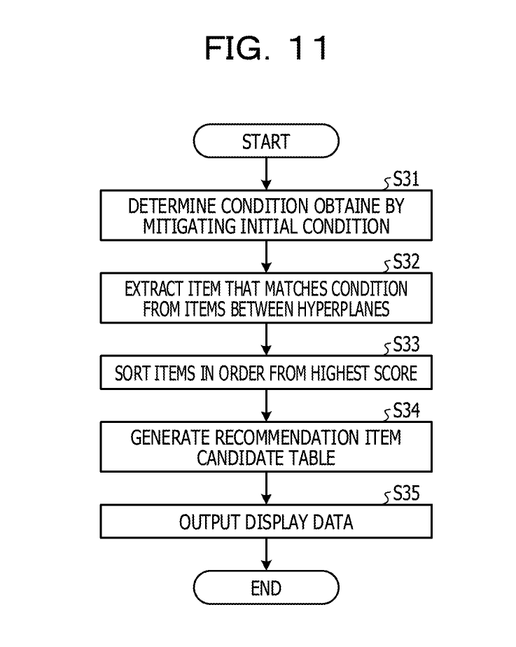

FIG. 11 is a diagram illustrating an exemplary generation of a recommendation item candidate table. As illustrated in FIG. 11, when the processing starts, the recommendation unit 80 determines a mitigation condition that has been obtained by mitigating the initial condition in the user search condition 112, based on the setting of the condition setting unit 70 (S31).

The recommendation unit 80 extracts an item that matches the mitigation condition from items (components) between the hyperplanes, which is described in the item-score table 125, with reference to the item information 113 (S32). Therefore, an item that matches the mitigation condition is selected from among the items outside the user search condition 112.

The recommendation unit 80 sorts the items that have been extracted in S32 in order from the highest score (S33). The recommendation unit 80 generates a recommendation item candidate table 130 including the item corresponding to the user search condition 112 and the items that have been obtained by sorting, in order from the highest score, the items each of which does not satisfy the user search condition 112 (S34).

The output unit 90 generates display data used to display an item described in the generated recommendation item candidate table 130 as an item recommended to the user, and performs output of the display data (S35).

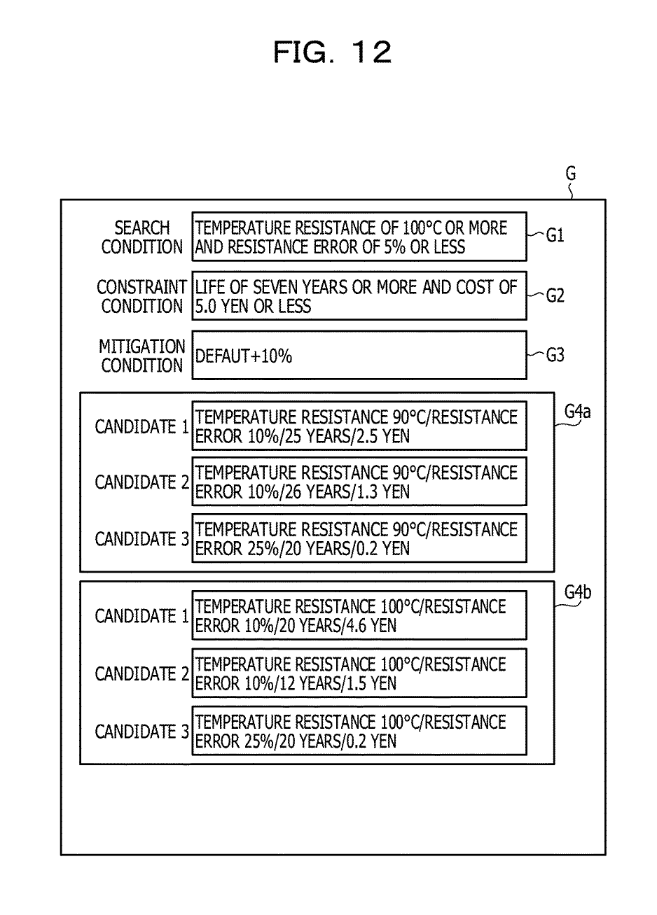

FIG. 12 is a diagram illustrating an exemplary display screen. As illustrated in FIG. 12, a display screen G includes a search condition G1, a constraint condition G2, a mitigation condition G3, and extraction results G4a and G4b. The search condition G1 and the constraint condition G2 are conditions input as the user search condition 112. For example, the search condition G1 may be a condition of a numeric value range of elements such as temperature resistance and an error. The constraint condition G2 is a condition that constrains the value of an element (life, cost, or the like) having the direction (desirability) of “good” or “bad” depending on the size of the value. The mitigation condition G3 is a condition obtained by mitigating the user search condition 112.

The extraction results G4a and G4b are extraction results of items recommended to the user, which are displayed based on the recommendation item candidate table 130. For example, the extraction result G4a is an extraction result of the items that have been extracted in order from the highest score from the items each of which does not satisfy the user search condition 112. The extraction result G4b is an extraction result of the items corresponding to the user search condition 112. The user may easily recognize a recommendation item corresponding to the input user search condition 112, by referring to the extraction results G4a and G4b. The user may easily find an item having high score from among the items each of which does not satisfy the input user search condition 112, with reference to the extraction result G4a. Therefore, a desirable item may be found without repeatedly searching for an item with a different search condition.

For example, an item that is a search target may be an electronic component (resistor). As the search condition, a condition (fixed condition) in which it is assumed that the temperature resistance is 100° C. or more, and the resistance error is 5% or less and a condition in which it is assumed that the life is seven years or more, and the cost is 5.0 yen or less (optimization condition) may be input.

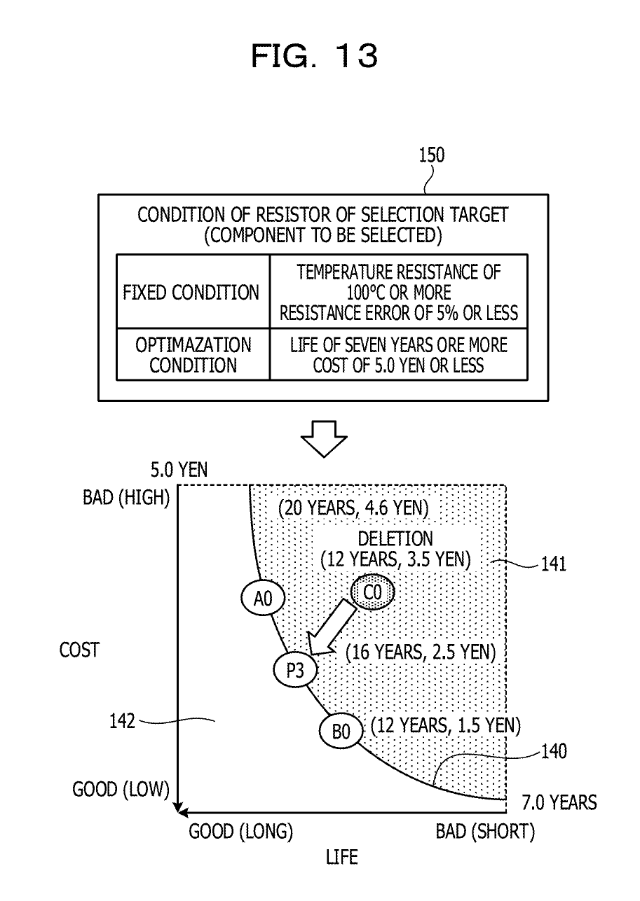

FIG. 13 is a diagram illustrating an exemplary Pareto generation. As illustrated in FIG. 13, the Pareto generation unit 40 performs Pareto generation under a constraint in which an input search condition 150 is satisfied, and obtains a Pareto curve 140. The Pareto generation unit 40 obtains items (A0, P3, and B0) on the Pareto curve 140. The previous history adjustment unit 50 performs history adjustment so as to substitute the items that have been previously selected by the user with corresponding items on the Pareto curve 140.

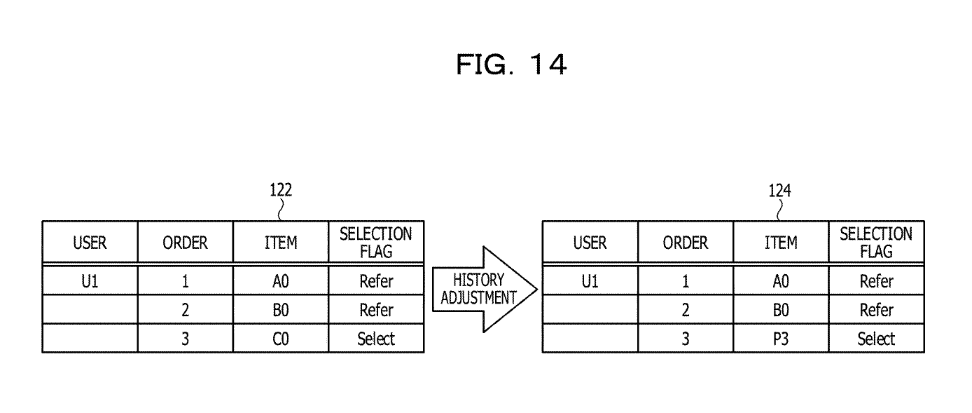

FIG. 14 is a diagram illustrating an exemplary history adjustment. As illustrated in FIG. 14, the previous history adjustment unit 50 substitutes an item that has been previously selected by a user (U1) (for example, C0) with a corresponding item on the Pareto curve 140 (for example, P3).

The score calculation unit 60 obtains a plurality of hyperplanes each of which passes through a component in which the selection flag is “Select” and a component in which the selection flag is “Refer”, based on the components on the Pareto curve 140 on which the previous selection order of the user has been reflected by the history adjustment. The score calculation unit 60 obtains a score for each of the components each of which does not satisfy the user search condition 112 by each of the obtained hyperplanes. The information extraction device 1 obtains an item candidate recommended to the user from the components each of which does not satisfy the user search condition 112, based on the scores.

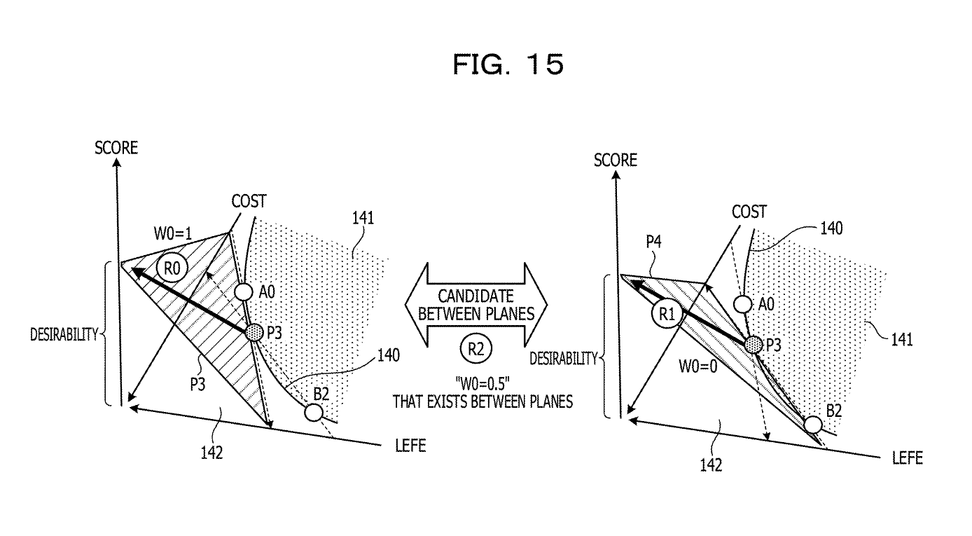

FIG. 15 is a diagram illustrating an exemplary item candidate. In FIG. 15, planes P3 and P4 created based on two elements, for example, the cost and the life of items are illustrated. As illustrated in FIG. 15, the plane P3 is a plane that passes through an item (P3) of “Select” and an item (A0) of “Refer”. The plane P4 is a plane that passes through the item (P3) of “Select” and an item (B2) of “Refer”.

For example, in the information extraction device 1, an item (R0) within the range 142 corresponding to the outside of the search condition 150, on the plane P3 may be an item candidate recommended to the user. An item (R1) in the range 142 corresponding to the outside of the search condition 150, on the plane P4 may be an item candidate recommended to the user. An item (R2) that exists at “W₀=0.5” between the planes P3 and P4 may be an item candidate recommended to the user.

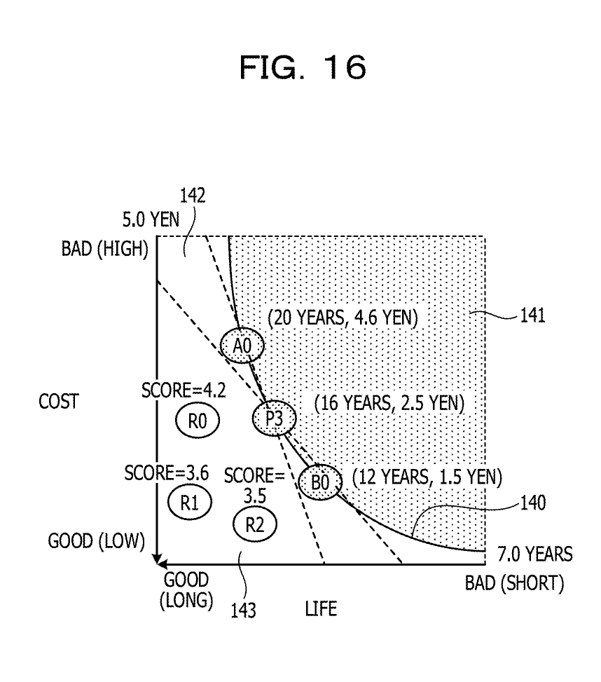

FIG. 16 is a diagram illustrating examples of scores of item candidates. As illustrated in FIG. 16, the score calculation unit 60 obtains, for each of the above-described items (R0 to R2), a score based on the formula (1) to generate an item-score table 125. The recommendation unit 80 outputs display data used to display the items each of which does not satisfy the user search condition 112 (R0 to R2) in order from the highest score (R0→R1→R2), based on the generated item-score table 125.

The score calculation unit 60 may sort the items in order of the calculated scores. For example, it is only sufficient that the sorting of the items is performed so that the user easily find a desirable item. In the sorting of the items, a degree that the item does not satisfy the user search condition 112 may be considered.

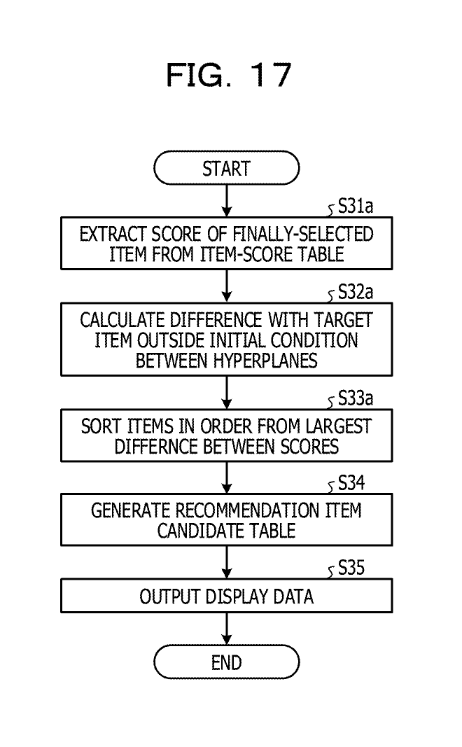

FIG. 17 is a diagram illustrating an exemplary generation of a recommendation item candidate table. In the processing of FIG. 17, it may be assumed that the processing of S31 and S32 illustrated in FIG. 11 has been already executed.

As illustrated in FIG. 17, when the processing starts, the output unit 90 extracts a score of a finally-selected item (item in which the selection flag is “Select”) from the item-score table 125 (S31a). The output unit 90 calculates a difference between a score that has been extracted in S31a and scores of the target items outside the initial condition between the hyperplanes, which are obtained from the item-score table 125 (items that has been extracted in S32) (S32a). The output unit 90 sorts the target items in order from the largest difference between the scores (S33a), and the processing proceeds to S34.

In the information extraction device 1, the extraction results that have been obtained by sorting the items in order from the largest score difference with the item in which the selection flag is “Select” in the items each of which does not satisfy the user search condition 112 are output. Therefore, for example, the user may easily find an item far from the user search condition 112.

The above-described various processing may be achieved by causing a computer such as a personal computer or a workstation to execute a program that has been prepared in advance.

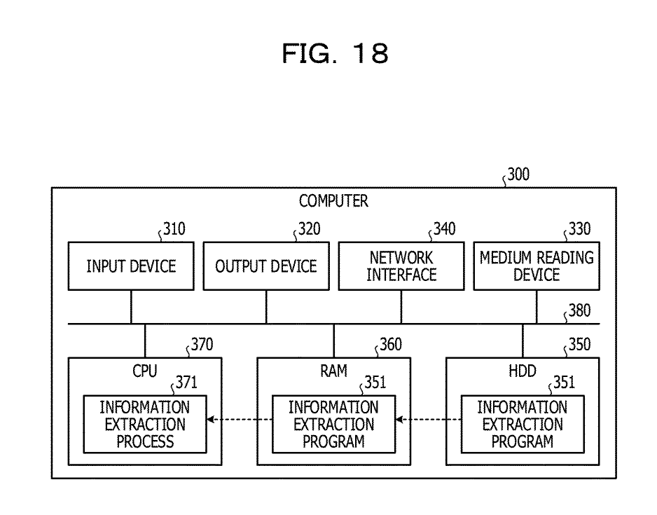

FIG. 18 is a diagram illustrating an exemplary computer. A computer 300 illustrated in FIG. 18 executes an information extraction program 351. As illustrated in FIG. 18, the computer 300 includes an input device 310 that accepts data and various setting from the user, and an output device 320 that performs notification of the computer status or the like. The computer 300 further includes a network interface 330 that transmits and receives data to and from a further device, a medium reading device 340, a hard disk drive (HDD) 350, a random access memory (RAM) 360, a central processing unit (CPU) 370, and a bus 380. The devices 310 to 370 is coupled to the bus 380.

As illustrated in FIG. 18, in the HDD 350, the information extraction program 351 that achieves functions similar to the units illustrated in FIG. 1 is stored in advance. The CPU 370 deploys the information extraction program 351 to the RAM 360, and executes the information extraction program 351 as an information extraction process 371. For example, in the information extraction process 371, operations similar to those of the input unit 10, the flag assignment unit 20, the similar user extraction unit 30, the Pareto generation unit 40, the previous history adjustment unit 50, the score calculation unit 60, the condition setting unit 70, the recommendation unit 80, and the output unit 90 are executed.

The information extraction program 351 may be stored in the HDD 350. For example, the information extraction program 351 may be stored in “portable physical medium” such as a flexible disk (FD), a compact disc-read-only memory (CD-ROM), a magneto optical (MO) disk, a digital versatile disc (DVD) disk, or an integrated circuit (IC) card inserted into the medium reading device 340 of the computer 300. The information extraction program 351 may be stored in “fixed physical medium” such as an HDD provided inside or outside the computer 300. The information extraction program 351 may be stored in “further computer system” coupled to the computer 300 through a public line, the Internet, a local area network (LAN), or a wide area network (WAN). The computer 300 may read the program from the medium or the system and execute the program.

For example, the information extraction program 351 may be computer-readable stored in the recording medium such as “portable physical medium”, “fixed physical medium”, or “communication medium”. The computer 300 achieves the above-described functions by reading the information extraction program 351 from such a recording medium and executing the information extraction program 351. The program may be executed by the computer 300, may be executed by a further computer system, a server, or the like, or may be executed through a combination of the computer 300 and the further computer system, the server, or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information extraction method, comprising:
extracting, by a computer, a plurality of item candidates that are candidates of Pareto-optimal items from among items included in item information, based on a search condition;
obtaining an order of the plurality of candidates based on history information indicating previously-selected items;
calculating a score for each of one or more first items that do not satisfy the search condition and is included in the item information based on the order; and
outputting one or more second items having a score which satisfies a specific condition from among the one or more first items based on the score.

2. The information extraction method according to claim 1, wherein
in the calculating the score, a plurality of hyperplanes each of which passes, in a multidimensional space including each element of the items, through a first item candidate having a first ranking in the order and a second item candidate having a second ranking in the order which is different from the first ranking are obtained while changing the second item candidate in a combination with the first item candidate, and a score of the first item is calculated in each of the plurality of hyperplanes.

3. The information extraction method according to claim 1, wherein
the history information corresponds to at least one of a first user who inputs the search condition and a second user whose previously-selected items are similar to the first user.

4. The information extraction method according to claim 1, further comprising:
accepting a setting of a mitigation condition which mitigates the search condition; and
outputting a recommendation item which satisfies the mitigation condition and has a score satisfying the specific condition.

5. The information extraction method according to claim 1, wherein
the one or more second items are output with the plurality of item candidates.

6. The information extraction method according to claim 1, wherein
the outputting is performed in order from high score.

7. The information extraction method according to claim 1, wherein
the one or more second items are output in order from a large score difference with an item at a specific ranking.

8. An information processing device comprising:
a processor configured to execute a program; and
a memory configured to store the program,
wherein the processor configured to, based on the program,
extract a plurality of item candidates that are candidates of Pareto-optimal items from among items included in item information, based on a search condition;
obtain an order of the plurality of candidates based on history information indicating previously-selected items;
calculate a score for each of one or more first items that do not satisfy the search condition and is included in the item information based on the order; and
output one or more second items having a score which satisfies a specific condition from among the one or more first items based on the score.

9. The information processing device according to claim 8, wherein
in an operation to calculate the score, a plurality of hyperplanes each of which passes, in a multidimensional space including each element of the items, through a first item candidate having a first ranking in the order and a second item candidate having a second ranking in the order which is different from the first ranking are obtained while changing the second item candidate in a combination with the first item candidate, and a score of the first item is calculated in each of the plurality of hyperplanes.

10. The information processing device according to claim 8, wherein
the history information corresponds to at least one of a first user who inputs the search condition and a second user whose previously-selected items are similar to the first user.

11. The information processing device according to claim 8, wherein the processor is configured to:
accept a setting of a mitigation condition which mitigates the search condition; and
output a recommendation item which satisfies the mitigation condition and has a score satisfying the specific condition.

12. The information processing device according to claim 8, wherein
the one or more second items are output with the plurality of item candidates.

13. The information processing device according to claim 8, wherein
an operation to output the one or more second items is performed in order from high score.

14. The information processing device according to claim 8, wherein
the one or more second items are output in order from a large score difference with an item at a specific ranking.

15. A computer-readable storage medium storing an information extraction program causing a computer to execute processing based on the information extraction program, the processing comprising:
extracting a plurality of item candidates that are candidates of Pareto-optimal items from among items included in item information, based on a search condition;
obtaining order of the plurality of candidates based on history information indicating previously-selected items;
calculating a score for each of one or more first items that do not satisfy the search condition and is included in the item information based on the order; and
outputting one or more second items having a score which satisfies a specific condition from among the one or more first items based on the score.

16. The computer-readable storage medium according to claim 15, wherein
in the calculating the score, a plurality of hyperplanes each of which passes, in a multidimensional space including each element of the items, through a first item candidate having a first ranking in the order and a second item candidate having a second ranking in the order which is different from the first ranking are obtained while changing the second item candidate in a combination with the first item candidate, and a score of the first item is calculated in each of the plurality of hyperplanes.

17. The computer-readable storage medium according to claim 15, wherein
the history information corresponds to at least one of a first user who inputs the search condition and a second user whose previously-selected items are similar to the first user.

18. The computer-readable storage medium according to claim 15, further comprising:
accepting a setting of a mitigation condition which mitigates the search condition; and
outputting a recommendation item which satisfies the mitigation condition and has a score satisfying the specific condition.

19. The computer-readable storage medium according to claim 15, wherein
the one or more second items is output with the plurality of item candidates.

20. The computer-readable storage medium according to claim 15, wherein
the outputting is performed in order from high score.
